(19) United States
(12) Patent Application Publication
(10) Pub. No.: US 2017/0362478 A1
(43) Pub. Date: Dec. 21, 2017

(54) BIODEGRADABLE PRESSURE-SENSITIVE ADHESIVE

(71) Applicant: TESA SE, Norderstedt (DE)

(72) Inventors: Tobias BLÖMKER, Hamburg (DE); Maike STREBL, Hamburg (DE)

(73) Assignee: TESA SE, Norderstedt (DE)

(21) Appl. No.: 15/623,916

(22) Filed: Jun. 15, 2017

(30) Foreign Application Priority Data
Jun. 17, 2016 (DE) 10 2016 210 898.0

(51) Int. Cl. C09J 175/04; C08G 18/32; C09J 7/04; C09J 7/02; C08G 18/10; C08G 18/83; C08G 18/73; C08G 18/66; C09J 5/00; C08G 18/22; C08G 18/42; C08K 5/42

(52) U.S. Cl. CPC C09J 175/04; C08G 18/227; C08G 18/3206; C09J 7/045; C09J 7/0285; C09J 7/026; C09J 7/0207; C08G 18/4238; C08G 18/10; C08G 18/833; C08G 18/73; C08G 18/664; C08G 18/4277; C09J 5/00; C08K 5/42; C09J 2475/00; C09J 2205/102

(57) ABSTRACT

A biodegradable pressure-sensitive adhesive which can be readily coated indirectly onto biodegradable carriers, which comprises

at least 60 wt % of at least one polyurethane, and
at least one sulfonated carboxylic ester; and a method for producing a biodegradable adhesive tape, which comprises
providing a pressure-sensitive adhesive of the invention as a dispersion in at least one organic solvent;
coating this dispersion onto a release liner;
removing the organic solvent; and
transferring the pressure-sensitive adhesive onto a biodegradable carrier.

This application claims priority of German Patent Application No. 10 2016 210 898.0, filed on Jun. 17, 2016, the entire contents of which is incorporated herein by reference.

### BACKGROUND OF THE INVENTION

The invention is situated within the field of pressure-sensitive adhesives, of the kind used diversely for the temporary or even permanent adhesive bonding of a very wide variety of substrates. The invention specifically relates to polyurethane-based biodegradable pressure-sensitive adhesives. It proposes the addition of a particular wetting agent, whereby the capacity for coating of release liners and also, surprisingly, biodegradability can be improved in the production of biodegradable adhesive tapes.

Pressure-sensitive adhesiveness is that property of a substance whereby it enters into a permanent bond to a substrate even under relatively weak applied pressure. Substances possessing this property are identified as pressure-sensitive adhesives (PSAs). PSAs are long-established products. Frequently they can be detached from the substrate again after use, with substantially no residue. PSAs generally at room temperature have a permanent inherent stickiness, thus having a certain viscosity and tack, and so they wet the surface of the respective substrate even under low applied pressure. The capacity of a PSA to adhere to materials and to transmit forces derives from the adhesion capacity and the cohesion of the PSA.

PSAs can be viewed as liquids of extremely high viscosity with an elastic component. Accordingly they have characteristic viscoelastic properties which result in the permanent inherent tack and adhesiveness.

A characteristic of PSAs is that when they are mechanically deformed, there are processes of viscous flow and there is also development of elastic forces of resilience. The two processes have a certain relationship to one another in terms of their respective proportion, in dependence not only on the precise composition, the structure, and the degree of crosslinking of the respective PSA but also on the rate and duration of the deformation, and on the temperature.

The proportional viscous flow is necessary for the achievement of adhesion. Only the viscous components, brought about by macromolecules with relatively high mobility, permit effective wetting and effective flow onto the substrate where bonding is to take place. A high viscous flow component results in high tack (also referred to as surface stickiness) and hence often also to high peel adhesion. Highly crosslinked systems, crystalline polymers, or polymers with glasslike solidification lack flowable components and are therefore in general devoid of tack or at least possess only little tack.

The proportional elastic forces of resilience are necessary for the attainment of cohesion. They are brought about, for example, by very long-chain macromolecules with a high degree of coiling, and also by physically or chemically crosslinked macromolecules, and they permit the transmission of the forces that act on an adhesive bond. As a result of these forces of resilience, an adhesive bond is able to withstand a long-term load acting on it, in the form of a long-term shearing load, for example, sufficiently over a relatively long time period.

For the more precise description and quantification of the extent of elastic and viscous components, and also of the proportion of the components to one another, the variables of storage modulus (G′) and loss modulus (G″) can be employed, as may be determined by means of Dynamic Mechanical Analysis (DMA). G′ is a measure of the elastic component, G″ a measure of the viscous component, of a substance. Both variables are dependent on the deformation frequency and on the temperature.

The variables can be determined with the aid of a rheometer. In that case, for example, the material under investigation, in the form of a plane-parallel layer, is exposed in a plate/plate arrangement to a sinusoidally oscillating shearing stress. In the case of instruments operating with shear stress control, the deformation is measured as a function of time, and the time offset of this deformation relative to the introduction of shear stress is recorded. This time offset is referred to as phase angle 6.

The storage modulus G′ is defined as follows: G′=(τ/γ)*cos(δ) (τ=shear stress, γ=deformation, δ=phase angle=phase shift between shear stress vector and deformation vector). The definition of the loss modulus G″ is as follows: G″=(τ/γ)*sin(δ) (τ=shear stress, γ=deformation, δ=phase angle=phase shift between shear stress vector and deformation vector).

A substance and the layer produced from it are deemed in general to be pressure-sensitively adhesive, and are defined as pressure-sensitively adhesive for the purposes of this specification, if at room temperature, here by definition at 23° C., in the deformation frequency range from 10⁰ to 10¹ rad/sec, G′ and G″ are each situated at least partly in the range from 10³ to 10⁷ Pa.

Within this range, which in a matrix plot of G′ and G″ (G′ plotted as a function of G″) may also be referred to as a viscoelastic window for PSA applications or as a PSA window according to viscoelastic criteria, there are in turn different sectors and quadrants which characterize more closely the PSA properties to be expected from the respective associated substances. Within this window, substances with high G″ and low G′ are generally notable, for example, for a high peel adhesion and a low shear strength, whereas substances with high G″ and high G′ are notable both for high peel adhesion and for high shear strength.

The findings on the correlations between rheology and pressure-sensitive adhesiveness, generally, are state of the art and are described for example in Satas, “Handbook of Pressure Sensitive Adhesive Technology”, Third Edition (1999), pages 153 to 203.

A bonding material or pressure-sensitive adhesive is chemically crosslinked when the bonding material or PSA has achieved, through chemical reaction with a crosslinker, a condition which renders it no longer meltable and no longer soluble in organic solvents. Liquification is then possible only through decomposition, which is irreversible. Crosslinkers contemplated include all substances which have a functionality of at least two and which are able to enter into chemical crosslinking reactions with the functional groups of the bonding material or PSA. Crosslinkers are selected according to the functional groups of the bonding material or PSA. Bonding materials or PSAs which carry carboxyl groups are crosslinked typically with di- or polyepoxides, possibly with additional catalysis, through tertiary amines, for example, or else with metal acetylacetonates, metal alkoxides, and alkoxy-metal acetylacetonates. For the crosslinking of bonding materials or PSAs which carry hydroxyl groups, for example, di- or polyisocyanates are appropriate.

Polymers or prepolymers which possess the property of being meltable and therefore thermoplastically processable are referred to in this specification—as customary in the terminology of the skilled person—as hotmelts.

A polyurethane prepolymer is understood in this specification to be an at least oligomeric, but preferably already itself polymeric reaction product, more particularly a meltable reaction product, which is obtained by chemical reaction of one or more polyols with one or more polyisocyanates, and which can be converted into a target polymer with a significant increase in the molar mass. Polyurethanes contain units linked to one another through urethane moieties —NH—CO—O—.

A polyurethane hotmelt prepolymer in this specification at room temperature has solidity and dimensional stability such that in known mixing assembles at room temperature, its continuous, homogeneous mixing with other substances, and also, in particular, its shaping or similar steps of processing, are not possible without the polyurethane hotmelt prepolymer heating up or without the addition of solvents, diluents or other viscosity-lowering additives being necessary. Examples of known mixing assemblies are compounders, internal mixers, extruders, planetary roller extruders, planetary mixers, butterfly mixers, or dissolvers. For the purposes of this specification, a polyurethane hotmelt prepolymer can be processed only when the polyurethane hotmelt prepolymer is dissolved in a solvent or when it is heated, in which case the heat may be supplied from the outside, by heating, or may be generated by shearing. Typical processing temperatures for polyurethane hotmelt prepolymers for the purposes of this specification are in the range from 70° to 160° C., and are at least 40° C. Room temperature is understood in this specification to be 23° C. Melting in this sense does not necessarily mean that at the moment of the transition from the solid, dimensionally stable state to the liquefied, miscible state, it is necessary for a crystalline melting temperature or a glasslike solidification temperature to be exceeded. What is meant at this point is a sufficient lowering of the viscosity.

A polyurethane hotmelt prepolymer for the purposes of this specification has a complex viscosity—as measured with a rheometer in an oscillation test with a sinusoidally oscillating shearing stress in a plate/plate arrangement at a temperature of 23° C. and with an oscillation frequency of 10 rad/s—of at least 1000 Pa*s, preferably at least 3000 Pa*s.

The complex viscosity η* is defined as follows: η*=G*/ω

(G*=complex shear modulus, ω=angular frequency).

The further definitions are as follows: G*=\sqrt{(G′)²+(G″)²}

(G″=viscosity modulus (loss modulus), G′=elasticity modulus (storage modulus)).

G″=τ/γ*sin(6) (τ=shear stress, γ=deformation, δ=phase angle=phase shift between shear stress vector and deformation vector).

G′=τ/γ*cos(6) (τ=shear stress, γ=deformation, δ=phase angle=phase shift between shear stress vector and deformation vector).

ω=2π·f (f=frequency).

Adhesive tapes which are furnished with pressure-sensitive adhesives, known as pressure-sensitive adhesive (PSA) tapes, are nowadays widely used in the industrial and private spheres. PSA tapes consist customarily of a carrier film, furnished on one or both sides with a PSA. There are also PSA tapes consisting exclusively of a layer of PSA and no carrier film, such tapes being called transfer tapes. The composition of the PSA tapes may vary greatly and is guided by the particular requirements of the various applications. The carriers consist customarily of polymeric films such as, for example, polypropylene, polyethylene, polyester, or else of paper or woven or nonwoven fabric.

The PSAs consist customarily of acrylate copolymers, silicones, natural rubber, synthetic rubber, styrene block copolymers, or polyurethanes.

On the basis of environmental considerations, sustainability, and against the background of increasingly scarce resources of crude oil, and, on the other hand, of a strongly growing consumption of plastics worldwide, there have for a number of years been efforts to produce plastics on the basis of renewable raw materials. This is so especially for biodegradable polymers which are to be used in packaging applications or film applications. For medical applications as well, biodegradable products are playing an increasingly important part. Some biobased or biodegradable plastics are commercially available today. Biobased means “produced from renewable raw materials”.

The term “biodegradable polymers” is used for natural and synthetic polymers which have plastics-like qualities (notched impact strength, thermoplastifiability) but which, in contrast to conventional plastics, are degraded by a multiplicity of microorganisms in a biologically active environment (compost, digested sludge, soil, wastewater); this does not necessarily take place under customary household conditions (garden composting). One definition of biodegradability is given in European Standards DIN EN 13432 (biodegradation of packaging) and DIN EN 14995 (compostability of plastics).

The skilled person makes a distinction between disintegration and biodegradability.

Disintegration refers to physical breakdown into very small fragments.

Determining the disintegrability (the degree of disintegration) of polymers is described in texts including DIN EN ISO 20200. In that case, the sample under analysis is stored in a defined artificial solids waste system at 58±2° C. for at least 45 and not more than 90 days. Thereafter the entire sample is passed through a 2 mm sieve and the degree of disintegration D is determined as follows:

Here

$$D = \frac{{m}_{i} - {m}_{r}}{{m}_{i}} \times 100$$

mᵢ is the initial dry mass of the sample material

and

mᵣ is the dry mass of the residual sample material obtained by sieving.

Biodegradability is understood in general as the capacity of a chemical compound or of an organic material to be broken down by microorganisms in the presence of oxygen into carbon dioxide, water, and salts of other elements present (mineralization), with formation of new biomass, or, in the absence of oxygen, into carbon dioxide, methane, mineral salts, and new biomass. Biodegradation is accomplished outside and/or inside the cell by bacteria, fungi, and microorganisms, and also their enzymes.

The biodegradability of packing materials is governed in terms of standards by DIN EN 13432 “Requirements for packaging recoverable through composting and biodegradation”. In this context, the material for testing is subjected to an aerobic degradation test in accordance with ISO 14855:1999 “Determination of the ultimate aerobic biodegradability of plastic materials under controlled composting conditions” and a degree of degradation of at least 90% must be achieved in comparison to a suitable reference substance within not more than six months. The degree of degradation here is determined by the measured evolution of carbon dioxide. After comminution, the sample is stored with vermiculite or highly functional aerated compost as inoculum in a vessel equipped with air supply at 58±2° C., and the evolution of CO₂ is recorded on an ongoing basis. In view of the complexity of apparatus, there are a number of testing institutes which have specialized in the testing and which subsequently issue a corresponding certificate, such as, for instance, OK compost from Vinçotte.

After the end of the testing, the degradation rate Dₜ is obtained as:

$${D}_{t} = \frac{{( {CO}_{2} )}_{T} - {( {CO}_{2} )}_{B}}{{Th CO}_{2}} \times 100$$

Here
(CO₂)_{T} is the cumulative amount of carbon dioxide formed in each composting vessel containing the test substance, in grams per vessel;
(CO₂)_{B} is the average cumulative amount of carbon dioxide formed in the control vessels, in grams per vessel;
ThCO₂ is the theoretical amount of carbon dioxide which the test substance can form, in grams per vessel.

In addition to the biodegradability, DIN EN 13432 also includes a test for determining the quality of the compost produced as a result of degradation. This compost must not have any adverse effects on plant growth.

Generally speaking, biodegradable components also have a high disintegration rate, whereas the disintegration of a material does not automatically imply its biodegradability.

In view of the fact that environmental considerations relating to biodegradability are playing an ever more important part not least for pressure-sensitive adhesive tapes, the past has also seen the presentation of PSA tapes which use biodegradable films as carrier material. The films used are frequently based on compounds of polylactic acid. Like other biodegradable thermoplastic polymers suitable for application, polylactic acid is relatively hard and brittle. In order to be suitable for film applications, these biodegradable polymers contemplated must be compounded with softer polymers, which in many cases lack or have poorer biodegradability.

In terms of the PSAs, the possibilities are further restricted. PSAs are amorphous materials with a low glass transition point.

The conventional scaffold polymers such as natural rubber, styrene block copolymers or polyacrylates are not biodegradable in accordance with the standards which apply in Europe, such as DIN EN 13432, for example. The same is true of the customary tackifier resins such as rosin derivatives, hydrocarbon resins or terpene-phenolic resins. Silicone PSAs are out of the question entirely, on account of their excellent stability with respect to aging. A criterion of biodegradability is customarily the presence of heteroatoms in the main carbon chain. A chemical bond between a carbon atom and a heteroatom such as oxygen or nitrogen, for example, is less stable and hence more amenable to biological degradation than is a bond between two carbon atoms.

In view of these circumstances, polyester PSAs are appropriate for such applications.

JP 2007 070 422 A1 describes a biodegradable PSA based on a polyester polyurethane which, however, has the disadvantage of being meltable. With meltable PSAs it is in principle not possible to achieve good bonding strengths at higher temperatures.

JP 63 189 486 A discloses a moisture-curing PSA based on a polyester polyurethane. Moisture-curing PSAs are problematic for use in adhesive tapes, where effective protection from ingress of moisture prior to application is a necessity.

JP 08 157 798 A proposes reacting a liquid polycaprolactone diol and a dicarboxylic acid with di- or polyisocyanates to give a PSA. The reactive system described is liquid to start with. Solidification occurs only after the PSA has been formed by the chemical reaction described. With regard to continuous coating, which in general represents the central operating step of a conventional adhesive tape manufacturing process, a disadvantage of liquid reactive systems is that in this state they cannot be wound, or at least not at constant layer thickness, onto a carrier material, especially not when the layer thicknesses in question are high.

Biodegradable PSAs and adhesive tapes are also described in WO 2015/189326 A1 and in WO 2015/189323 A1.

Particular challenges are presented when producing biodegradable adhesive tapes. For such adhesive tapes, of course, biodegradable carrier materials are also used. These materials, however, are frequently of low temperature stability and/or solvent resistance, as is the case, for example, with materials based on polylactic acid. Consequently, such carriers can often not be coated directly. In that case, coating takes place first onto a temporary carrier—which in general is not biodegradable—and lamination to the biodegradable carrier takes place only after the solvent has been removed and cooling has taken place.

A problem which arises here, however, is that because of the high differences in polarity, polyurethane-based biodegradable PSAs have a tendency not to readily wet the temporary carrier materials with their usually low-polarity release coatings. Consequently, the PSAs do not apply well to such carriers, and the entire operation is jeopardized.

### SUMMARY OF THE INVENTION

It is an object of the present invention, therefore, to provide biodegradable PSAs which can readily be coated indirectly onto biodegradable carriers without this facility being at the cost of their biodegradability. Furthermore, adverse effects on the peel adhesion, even after prolonged storage, are to be avoided. Another object of the invention is to provide a method for producing biodegradable adhesive tapes with which it is possible, in a practicable way, to apply biodegradable PSAs to biodegradable carrier materials, and with which strongly performing biodegradable adhesive tapes can be obtained.

The achievement of the objects is based on the concept of using polyurethane-based biodegradable PSAs and to ally them with specific wetting agents.

A first, general subject of the invention is a biodegradable pressure-sensitive adhesive which comprises at least 60 wt % of at least one polyurethane, and also at least one sulfonated carboxylic ester.

It has emerged that a pressure-sensitive adhesive (PSA) of the invention can be coated very effectively onto temporary carrier materials, as for example onto conventional, siliconized release liners. In such a procedure, degrees of wetting of 95% to 100% are achieved. As has likewise emerged, the biodegradability of the PSAs is in many cases actually improved further as a result of adding the sulfonated carboxylic ester or esters.

### DETAILED DESCRIPTION

The at least one polyurethane is obtainable preferably by chemical crosslinking of a polyurethane prepolymer which in turn is obtainable by chemical reaction of
a) one or more aliphatic polyester polyols A having a hydroxyl functionality of 1.8 up to and including 2 and a number-averaged molecular weight of greater than/equal to 1000 g/mol;
b) one or more compounds B having a hydroxyl functionality of 1.8 up to and including 2 and a number-averaged molecular weight of less than 1000 g/mol;
c) one or more aliphatic diisocyanates C,

the ratio of the total number of isocyanate groups to the total number of hydroxyl groups in the substances involved in the chemical reaction for the synthesis of the polyurethane prepolymer being greater than/equal to 0.4 and less than 1.

The number-averaged molecular weight of the polyester polyols A is preferably more than 1500 g/mol and more preferably more than 2000 g/mol.

The hydroxyl functionality is understood as the number of hydroxyl groups per molecule of a polyol. In this specification, it is expressed relative to the number-averaged average molecular weight of the respective polyol, and is calculated according to the following formula:

f=Mₙ[g/mol]×OHN [mmol OH/kg]/10⁶

f is the hydroxyl functionality. Mₙ is the number-averaged average molecular weight of the respective polyol in the unit [g/mol] and OHN is the hydroxyl number of the polyol in the unit [mmol OH/kg].

The hydroxyl number is a measure of the amount of hydroxyl groups in a polyol. The hydroxyl number is determined according to DIN 53240. According to that method, the hydroxyl number (OHN) is expressed in the unit [mg KOH/g]. It corresponds to the amount of KOH in [mg] which is equivalent to the amount of acetic acid bound in the acetylation of 1 g of polyol. For simplification of formula calculations, the hydroxyl number in this specification is converted into the unit [mmol OH/kg].

This is done according to the following formula:

OHN [mmol OH/kg]=OHN [mg KOH/g]×1000/56.1

where 56.1 is the molar mass of KOH.

The preferred hydroxyl functionality of the polyester polyols A, of 1.8 to 2, represents a high degree of difunctionality, thereby allowing the construction of linear prepolymers.

Suitable polyester polyols A include all commercial aliphatic polyester polyols having the described molecular weight, provided they have the preferred hydroxyl functionality. Preferred polyester polyols are obtained generally by polycondensation of diols and dicarboxylic acids or, in the case of polycaprolactone polyols, by ring-opening polymerization from ε-caprolactone and a difunctional starter molecule.

Preferably at least one of the polyester polyols A, more preferably the polyester polyol A or the polyester polyols A, is/are the product of a chemical reaction of one or more organic dicarboxylic acids selected from the group consisting of adipic acid, maleic acid, succinic acid, caprolactones, fumaric acid, pimelic acid, suberic acid, and glutaric acid; more preferably selected from the group consisting of adipic acid, succinic acid, caprolactones, fumaric acid, pimelic acid, suberic acid, and glutaric acid; with one or more diols selected from the group consisting of ethylene glycol, diethylene glycol, triethylene glycol, propylene 1,2-glycol, 1,3-propanediol, 1,4-butanediol, 1,6-hexanediol, 3-methyl-1,5-pentanediol, 2,2,4-trimethylpentane-1,3-diol, 2-butyl-2-ethyl-1,3-propanediol, 2,2-dimethyl-1,3-propanediol, 2-methyl-1,3-propanediol, 2-ethyl-1,3-hexanediol.

The dicarboxylic acid unit of the polyester polyols is more preferably adipic acid and/or ε-caprolactone. Preferred polyester polyols are therefore polyadipate polyols and/or polycaprolactone polyols.

The alcohol unit of the polyester polyols is preferably ethylene glycol, diethylene glycol, 1,4-butanediol and/or 1,6-hexanediol. With particular preference at least one of the polyester polyols is a polyadipate polyol comprising ethylene glycol and/or diethylene glycol as monomer unit.

It has further emerged that polyester polyols which carry methyl groups, in other words polyester polyols containing, for example, 2-methyl-1,3-propanediol, 3-methyl-1,5-pentanediol or neopentyl glycol as alcohol unit, may be advantageous for achieving desired pressure-sensitive adhesive performance, but tend to be disadvantageous for rapid biodegradability of the polyurethanes prepared using them. Surprisingly, however, even polyurethanes synthesized from prepolymers comprising such units can be sufficiently rapidly biodegraded in combination with the rest of the components described herein.

With preference the polyester polyols A are prepared from renewable raw material sources, as for example by fermentation of starch or sugar.

The compounds B are preferably selected from the group consisting of polyester diols having a number-averaged molecular weight of up to 600 g/mol, more preferably of up to 450 g/mol; 2-methyl-1,3-propanediol, 3-methyl-1,5-pentanediol, ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 2-ethyl-1,3-hexanediol, and 2-butyl-2-ethyl-1,3-propanediol. With particular preference the compounds B are selected from the group consisting of polyester diols having a number-averaged molecular weight of up to 450 g/mol, 2-methyl-1,3-propanediol (CAS No.: 2163-42-0), 3-methyl-1,5-pentanediol (CAS No.: 4457-71-0), ethylene glycol (CAS No.: 107-21-1), diethylene glycol (CAS No.: 111-46-6), triethylene glycol (CAS No.: 112-27-6), and tetraethylene glycol (CAS No.: 112-60-7). More particularly the compound B is diethylene glycol and/or a polyester diol having a number-averaged molecular weight of up to 450 g/mol.

Suitable disocyanates C for example are as follows: butane 1,4-diisocyanate, tetramethoxybutane 1,4-diisocyanate, pentane 1,5-diisocyanate, hexane 1,6-diisocyanate, ethylene diisocyanate, 2,2,4-trimethylhexamethylene diisocyanate, ethylethylene diisocyanate, dicyclohexylmethane diisocyanate, 1,4-diisocyanatocyclohexane, 1,3-diisocyanatocyclohexane, 1,2-diisocyanatocyclohexane, 1,3-diisocyanatocyclopentane, 1,2-diisocyanatocyclopentane, 1,2-diisocyanatocyclobutane, 1-isocyanatomethyl-3-isocyanato-1,5,5-trimethylcyclohexane (isophorone diisocyanate), 1-methyl-2,4-diisocyanatocyclohexane, 1,6-diisocyanato-2,2,4-trimethylhexane, 1,6-diisocyanato-2,4,4-trimethylhexane, 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-1-(4-isocyanatobut-1-yl)-1,3,3-trimethylcyclohexane, 1-isocyanato-2-(3-isocyanatoprop-1-yl)-cyclohexane, 1-isocyanato-2-(2-isocyanatoeth-1-yl)cyclohexane, 2-heptyl-3,4-bis(9-isocyanatononyl)-1-pentylcyclohexane, norbornane diisocyanatomethyl, hydrogenated diphenylmethane diisocyanates such as 4,4′-diisocyanatodicyclohexylmethane, and also chlorinated, brominated, sulfur- or phosphorus-containing aliphatic diisocyanates.

Particularly preferred are the diisocyanates C selected from the group consisting of isophorone diisocyanate, 4,4′-diisocyanatodicyclohexylmethane, pentane 1,5-diisocyanate, and hexane 1,6-diisocyanate.

The chemical reaction through which the polyurethane prepolymer is obtainable proceeds preferably in the presence of at least one bismuth carboxylate-containing or bismuth carboxylate derivative-containing catalyst or catalyst mixture that is known in principle, when used, to accelerate polyurethane reactions. A catalyst of this kind considerably steers the pressure-sensitive adhesion properties of the polyurethane to be prepared from the prepolymer in such a way that the pressure-sensitive adhesion properties achieve a surface-specific selectivity. Examples of such catalysts are bismuth trisdodecanoate, bismuth trisdecanoate, bismuth trisneodecanoate, bismuth trisoctanoate, bismuth trisisooctanoate, bismuth trishexanoate, bismuth trispentanoate, bismuth trisbutanoate, bismuth trispropanoate, and bismuth trisacetate.

It is also possible, however, to use other known catalysts, such as tertiary amines or organotin compounds, for example.

The ratio of the total number of isocyanate groups to the total number of hydroxyl groups of the substances involved in the chemical reaction to synthesize the polyurethane prepolymer is preferably greater than/equal to 0.7 and less than 1; more preferably greater than/equal to 0.7 and less than/equal to 0.95; very preferably greater than/equal to 0.75 and less than/equal to 0.9. The expression “substances involved in the chemical reaction” identifies, for the purposes of the invention, all reactants which are brought into contact with one another for the purpose of the intended chemical reaction, irrespective of whether the molecules of the respective substances are in fact all or only partly consumed by reaction.

The amount-of-substance ratio of the sum total or of the entirety of the compounds B to the sum total or of the entirety of the polyester polyols A is preferably 0.30 to 2.33, more preferably 0.45 to 1.5 and more particularly 0.5 to 1.

Preferred polyurethanes, obtainable by the crosslinking of the above-described prepolymers, of the PSA of the invention have very good biodegradability. In view of the high linear structural components, the expectation will have been that the polyurethanes would have no pressure-sensitive adhesion properties at all, or at least only weakly pronounced such properties. Surprisingly, however, it emerged that the polyurethanes had very good pressure-sensitive adhesion properties over a wide range. For instance, peel adhesions on steel (180°, 300 mm/min, based on PSTC-1) of at least 0.5 N/cm were obtained.

The chemical crosslinking of the polymer to give the preferred polyurethane takes place preferably using at least one polyisocyanate D having three or more isocyanate groups. Preferred polyisocyanates D are the trimers of the diisocyanates C, more particularly the trimers of hexane 1,6-diisocyanate and pentane 1,5-diisocyanate. The ratio of the sum total of the isocyanate groups of all polyisocyanates C and D to the sum total of the hydroxyl groups of components A and B is preferably 0.95 to 1.05.

The chemical crosslinking to give the preferred polyurethane may in principle take place solventlessly, in other words in the melt; in an organic solvent; or in aqueous dispersion. In the two latter cases, both the polyurethane prepolymer and the crosslinker, preferably therefore the polyisocyanate(s) D, are present in solution in an organic solvent and/or in dispersion in water. In line with the method of the invention, presented later on in this text, for producing an adhesive tape of the invention, the crosslinking to give the polyurethane preferably takes place in substantial part after the delivery of a dispersion of the prepolymer blended with the crosslinker onto a temporary carrier, while the organic solvent is removed. Drying and crosslinking therefore preferably take place largely simultaneously.

The PSA of the invention contains the polyurethane(s), more particularly the preferred polyurethane(s), preferably to an extent of at least 70 wt %, more preferably at least 80 wt %, more particularly at least 90 wt %, very preferably at least 95 wt %, as for example at least 97 wt %. An advantage of this PSA is that—at least in large part—it is biodegradable in an aqueous medium and can be disintegrated in a standardized compost.

As already maintained, the preferred polyurethane is per se pressure-sensitively adhesive. Through controlled guidance of the reactions for the synthesis and for the crosslinking of the polyurethane prepolymer, it is possible to adjust the pressure-sensitive adhesion properties of the preferred polyurethane within a broad range.

In a further embodiment of the PSA of the invention, the at least one polyurethane is a chemical reaction product of
at least one or more aliphatic polyester polyols having a hydroxyl functionality of in each case between greater than two and less than four;
at least one or more aliphatic polyester polyols having a hydroxyl functionality of in each case between less than or equal to two and greater than one;
at least one or more in each case doubly hydroxy-functionalized chain extenders having a molecular weight of in each case less than or equal to 200 g/mol; and
at least one or more aliphatic diisocyanates,

where the ratio of the total number of isocyanate groups to the total number of hydroxyl groups of the substances introduced in the chemical reaction to give the chemical reaction product is between greater than or equal to 0.4 and less than 1.0, preferably between greater than or equal to 0.6 and less than or equal to 0.9.

An aliphatic polyester polyol is understood here to be an acyclic or cyclic, saturated or unsaturated polyester polyol which contains no aromatic rings in its chemical structure.

Suitable polyester polyols of the further embodiment include all commercial aliphatic polyester polyols. Polyester polyols are obtained generally by polycondensation of diols or triols or higher-functionality alcohols and dicarboxylic acids or, in the case of polycaprolactone polyols, by ring-opening polymerization from ε-caprolactone and a starter molecule having a functionality of two or three or higher.

With regard to the dicarboxylic acid unit of the polyester polyols of the further embodiment, adipic acid is preferred. Preferred polyester polyols are therefore polyadipate polyols. Likewise preferred are polycaprolactone polyols.

With regard to the diol, triol or higher-functionality alcohol unit of the polyester polyols of the further embodiment, ethylene glycol or diethylene glycol are preferred. With particular preference at least one of the aliphatic polyester polyols is a polyadipate polyol comprising ethylene glycol or diethylene glycol as monomer unit.

1,4-Butanediol and 1,6-hexanediol are likewise suitable. Mixtures of the stated diols are highly suitable as well. Carbonate groups contained in the polyester polyol are likewise advantageous. Disadvantageous in terms of achieving rapid biodegradability are polyester polyols with a functionality of three or more, and also polyester polyols which carry methyl groups, in other words polyester polyols which include, for example, 2-methyl-1,3-propanediol, 3-methyl-1,5-pentanediol or neopentyl glycol as alcohol unit.

Preferred chain extenders are 2-methyl-1,3-propanediol (CAS No.: 2163-42-0), 3-methyl-1,5-pentanediol (CAS No.: 4457-71-0), ethylene glycol (CAS No.: 107-21-1) or, more preferably, diethylene glycol (CAS No.: 111-46-6), triethylene glycol (CAS No.: 112-27-6) or tetraethylene glycol (CAS No.: 112-60-7). Also highly suitable are propylene glycol, dipropylene glycol, tripropylene glycol, 1,3-propanediol, 1,3-butanediol, 1,4-butanediol, neopentyl glycol, 1,6-hexanediol, 2-ethyl-1,3-hexanediol, and 2-butyl-2-ethyl-1,3-propanediol. Other known chain extenders having a molecular weight of less than or equal to 200 g/mol are not excluded from the concept of the invention.

Diisocyanates of the further embodiment that are used are aliphatic diisocyanates. Aliphatic diisocyanates here are understood to be acyclic or cyclic, saturated or unsaturated diisocyanates which contain no aromatic rings in their chemical structure.

Very preferably, at least one of the aliphatic diisocyanates is 4,4′-diisocyanatodicyclohexylmethane, abbreviated to H₁₂MDI (CAS No.: 5124-30-1), or hexamethylene diisocyanate, abbreviated to HDI (CAS No.: 822-06-0). Particularly preferred with regard to the rapidity of biodegradability are pentamethylene diisocyanate and hexamethylene diisocyanate.

1-Isocyanatomethyl-3-isocyanato-1,5,5-trimethylcyclohexane (isophorone diisocyanate) may likewise be used:

Further examples of suitable diisocyanates are:

Butane 1,4-diisocyanate, tetramethoxybutane 1,4-diisocyanate, ethylene diisocyanate, 2,2,4-trimethylhexamethylene diisocyanate, ethylethylene diisocyanate, 1,4-diisocyanatocyclohexane, 1,3-diisocyanatocyclohexane, 1,2-diisocyanatocyclohexane, 1,3-diisocyanatocyclopentane, 1,2-diisocyanatocyclopentane, 1,2-diisocyanatocyclobutane, 1-methyl-2,4-diisocyanatocyclohexane, 1,6-diisocyanato-2,2,4-trimethylhexane, 1,6-diisocyanato-2,4,4-trimethylhexane, 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-1-(4-isocyanatobut-1-yl)-1,3,3-trimethylcyclohexane, 1-isocyanato-2-(3-isocyanatoprop-1-yl)cyclohexane, 1-isocyanato-2-(2-isocyanatoeth-1-yl)cyclohexane, 2-heptyl-3,4-bis(9-isocyanatononyl)-1-pentylcyclohexane, and norbomane diisocyanatomethyl.

The ratio of the total number of isocyanate groups to the total number of hydroxyl groups in the substances introduced in the chemical reaction to give the chemical reaction product of the further embodiment is preferably between greater than or equal to 0.6 and less than or equal to 0.9.

Likewise with preference the chemical reaction product of the further embodiment is a hydroxyl-functionalized polyurethane hotmelt prepolymer.

Preferably, at least one of the aliphatic polyester polyols has a hydroxyl number of between greater than or equal to 200 mmol OH/kg and less than or equal to 2000 mmol OH/kg. This corresponds in the case of polyester diols to a number-averaged average molecular weight between 1000 and 10 000 g/mol and in the case of polyester triols to between 1500 and 15 000 g/mol.

With further preference at least one of the aliphatic polyester polyols having a hydroxyl functionality of between greater than two and less than four has a hydroxyl number of between greater than or equal to 200 mmol OH/kg and less than or equal to 2000 mmol OH/kg.

With further preference, the amount-of-substance fraction of hydroxyl groups originating from the aliphatic polyester polyols having a hydroxyl functionality of between greater than two and less than four is at least 2.5%, preferably at least 5%, more preferably at least 7.5% of all hydroxyl groups introduced for forming the chemical reaction product of the further embodiment.

More preferably, in the context of the further embodiment
at least one of the aliphatic polyester polyols has a hydroxyl functionality of between greater than two and less than four and a hydroxyl number of between greater than or equal to 200 mmol OH/kg and less than or equal to 2000 mmol OH/kg and
at least one of the aliphatic polyester polyols has a hydroxyl functionality of between less than or equal to two and greater than one and a hydroxyl number of between greater than or equal to 200 mmol OH/kg and less than or equal to 8000 mmol OH/kg,

and the amount-of-substance fraction of hydroxyl groups originating from the aliphatic polyester polyols having a hydroxyl functionality of between greater than two and less than four and a hydroxyl number of between greater than or equal to 200 mmol OH/kg and less than or equal to 2000 mmol OH/kg is between 2.5% inclusive and 50% inclusive, preferably between 5.0% inclusive and 40% inclusive, more preferably between 7.5% inclusive and 30% inclusive of all hydroxyl groups introduced for forming the chemical reaction product.

Likewise preferably, in the context of the further embodiment
at least one of the aliphatic polyester polyols has a hydroxyl functionality of between greater than two and less than four and a hydroxyl number of between greater than or equal to 200 mmol OH/kg and less than or equal to 2000 mmol OH/kg and
at least one of the aliphatic polyester polyols has a hydroxyl functionality of between less than or equal to two and greater than one and a hydroxyl number of between greater than or equal to 200 mmol OH/kg and less than or equal to 2000 mmol OH/kg,

and the amount-of-substance fraction of hydroxyl groups originating from the aliphatic polyester polyols having a hydroxyl functionality of between greater than two and less than four and a hydroxyl number of between greater than or equal to 200 mmol OH/kg and less than or equal to 2000 mmol OH/kg is between 2.5% inclusive and 50% inclusive, preferably between 5.0% inclusive and 40% inclusive, more preferably between 7.5% inclusive and 30% inclusive of all hydroxyl groups introduced for forming the chemical reaction product.

The chemical reaction product of the further embodiment is chemically branched, but uncrosslinked, and can be chemically crosslinked to form a PSA or bonding material. The chemical crosslinking of the chemical reaction product is accomplished advantageously by reacting the chemical reaction product with a diisocyanate, triisocyanate or higher-functionality isocyanate or with a mixture of said isocyanates, the ratio of the total number of all isocyanate groups to the total number of all hydroxyl groups in the substances introduced overall in the chemical reaction to give the chemical reaction product and in the subsequent chemical crosslinking to give the pressure-sensitive adhesive or bonding material being less than 1.0, preferably less than 0.95, and more preferably less than or equal to 0.9.

Isocyanates particularly advantageous for the crosslinking step of the further embodiment are HDI trimers comprising isocyanurate rings, an example being Desmodur® N 3300 from Bayer, which additionally also comprises pentamers, heptamers, and fractions of higher functionality as well. HDI dimers comprising uretdione rings, such as Desmodur® N 3400 from Bayer, for example, which also comprises trifunctional components as well, are likewise suitable. Also suitable are mixtures of the stated isocyanates and also mixtures with other di- or polyisocyanates.

Advantageous for the chemical reaction to give the chemical reaction product and also for the crosslinking step is the use of a bismuth carboxylate-containing or bismuth carboxylate derivative-containing catalyst or catalyst mixture that is known, when used, to accelerate polyurethane reactions. A catalyst of this kind considerably steers the pressure-sensitive adhesion properties of the polyurethane in such a way that the pressure-sensitive adhesion properties can be given a surface-specific selectivity. Examples of bismuth carboxylates are bismuth trisdodecanoate, bismuth trisdecanoate, bismuth trisneodecanoate, bismuth trisoctanoate, bismuth trisisooctanoate, bismuth trishexanoate, bismuth trispentanoate, bismuth trisbutanoate, bismuth trispropanoate or bismuth trisacetate.

It is also possible, however, to use all other catalysts known to the skilled person, such as tertiary amines or organotin compounds, for example.

With further preference the polyols and/or chain extenders are produced from renewable raw material sources such as, for example, by fermentation of starch or sugar.

In order to adapt the properties of the PSA of the invention, the polyurethane or polyurethanes generally can be mixed with one or more additives such as tackifiers (tackifying resins), plasticizers and/or aging inhibitors.

Preferably, however, the PSA of the invention is free of tackifiers (tackifying resins) and plasticizers, more preferably free from tackifiers (tackifying resins), plasticizers, and aging inhibitors, and more particularly free from any additives, except of course for the sulfonated carboxylic esters used in accordance with the invention. Residues of any substances resulting from production or otherwise, being essentially the result of incomplete removal, and also substance amounts in the range of an omnipresent concentration, are immaterial.

The designation “tackifier resin” is understood by the skilled person to refer to a resin-based substance which enhances the tack.

Tackifiers are, for example, hydrocarbon resins (for example, polymers based on unsaturated C₅ or C₉ monomers), terpene-phenolic resins, polyterpene resins based on α-pinene and/or β-pinene and/or δ-limonene, aromatic resins such as coumarone-indene resins, or resins based on styrene or α-methylstyrene, and also rosin and its derivatives, examples being disproportionated, dimerized or esterified resins, as for example reaction products with glycol, glycerol or pentaerythritol. Preference is given to using natural resins such as rosins and derivatives thereof. Particular preference is given to using biodegradable tackifier resins, such as, for instance, sugar esters of biodegradable carboxylic acids such as of benzoic acid. One example is sucrose benzoate.

The addition of nonbiodegradable tackifiers in minor amounts of up to 1 wt % is possible without losing the biodegradability of the PSA. In the case of larger amounts added to the adhesive, however, it is possible that it will no longer be biodegradable. Preferably, the PSA of the invention is free of nonbiodegradable tackifiers, more preferably free of any tackifiers.

Examples of suitable plasticizers incorporable by mixing are aliphatic and aromatic mineral oils, polyethylene glycol and polypropylene glycol, diesters or polyesters of phthalic acid, citric acid, trimellitic acid or adipic acid, liquid rubbers (for example, low molecular mass nitrile rubbers or polyisoprene rubbers), liquid polymers of butene and/or isobutene, acrylic esters, polyvinyl ethers, liquid resins and soft resins based on the raw materials of tackifier resins, wool wax and other waxes, or liquid silicones. Particular preference is given to using plasticizers comprising renewable raw materials, such as the biobased polyoxytrimethylene glycol Cerenol® from DuPont, for example, vegetable oils, preferably refined vegetable oils such as, for example, rapeseed oil and soybean oil; fatty acids or fatty acid esters, or epoxidized vegetable oils, such as epoxidized soybean oil.

Used more particularly are biodegradable plasticizers, preferably diesters or polyesters of citric acid or of adipic acid.

With further preference the plasticizer, more particularly the biodegradable plasticizer, is used in amounts of up to 10 wt %, very preferably in amounts of up to 5 wt %, and especially preferably in amounts of up to 2.5 wt %, based in each case on the total weight of the PSA.

As for the tackifiers, the addition of any plasticizers in minor amounts of up to 1 wt % is possible without loss of the biodegradability of the PSA. Here again it is the case that in the case of more substantial amounts added to the adhesive, it is possible that the adhesive will no longer be biodegradable. Preferably, therefore, plasticizers are not used, or biodegradable plasticizers are used.

Further possible additives in the PSA are fillers, as for example fibers, carbon black, zinc oxide, titanium dioxide, chalk, solid or hollow glass beads, microballoons, microspheres of other materials, silica, silicates, nanoparticles, wood flour, starch and starch compounds, and other biobased fillers; compounding agents and/or aging inhibitors, the latter in the form, for example, of primary and secondary antioxidants, examples being sterically hindered phenols such as Irganox 1010 and more preferably tocopherol (vitamin E). Light stabilizers as well may be added.

The fillers are subject to what has already been said for the tackifiers and plasticizers: in minor amounts of up to 1% by weight, the addition even of nonbiodegradable fillers is possible without substantial detriment to the biodegradability of the PSA. In the case of larger amounts added to the at least one polyurethane, it is possible that the PSA will no longer be adequately biodegradable. With preference therefore, fillers, and more particularly those which are not biodegradable, are not used. Biodegradable fillers, in contrast, may find use even in more substantial amounts.

The PSA of the invention comprises at least one sulfonated carboxylic ester. On account of their surfactant character, these esters act as wetting assistants and in that way improve the capacity for the PSA to be coated onto temporary carrier materials more particularly onto release layers. The surfactant character of the sulfonated carboxylic esters is determined on the one hand by the ionic structure of the sulfonic acid and on the other by the alkyl chains of the alcohol on which the carboxylic ester is based. The carboxylic acid on which the sulfonated carboxylic ester is based (and which is therefore yet to be sulfonated) is preferably a dicarboxylic acid, and more particularity it is selected from the group consisting of maleic acid, fumaric acid, methylmaleic acid, mesaconic acid, and itaconic acid. The alcohol component on which the sulfonated carboxylic ester is based is preferably selected from the group consisting of 2-ethylhexan-1-ol, 5-ethylheptan-2-ol, 10-methylundecan-1-ol, 2-propylheptan-1-ol, 2-ethylheptan-1-ol, octadecan-1-ol, 2-dodecanol, 2-nonanol, isobutanol, tridecan-1-ol, cyclohexanol, 1-hexanol, amyl alcohol, and octan-1-ol. The ester, if it is based on a dicarboxylic acid, may have either a symmetrical or an asymmetrical construction—that is, it may be esterified with two identical or different alcohols. In the asymmetric construction, the second alcohol residue may also carry short C₂-C₈ alkyl radicals. Preferred alcohols for this purpose are methanol, ethanol, 1-butanol, isopropanol, and pentan-1-ol. With particular preference the sulfonated carboxylic ester is a symmetrically constructed dicarboxylic ester. With particular preference the acid components of the sulfonated carboxylic ester are selected from the group consisting of sulfosuccinic acid, sulfoglutaric acid, sulfo-2-methylglutaric acid, sulfo-3-methylglutaric acid, sulfo-α-ketoglutaric acid, sulfoadipic acid, sulfopimelic acid, sulfoazelaic acid, sulfosebacic acid, sulfobrassylic acid, sulfofumaric acid, sulfo-2,2-dimethylglutaric acid, sulfosuberic acid, sulfo-oxalacetic acid, sulfoglutamic acid, and sulfoaspartic acid. With very particular preference the at least one sulfonated carboxylic ester is a dialkylester of sulfosuccinic acid, very preferably bis-2-ethylhexyl sulfosuccinate.

Sulfonated carboxylic esters in the dispersion of the PSA of the invention that is to be coated onto a carrier material are present preferably at in total 0.1-3.0 wt %, more preferably at in total 0.2-2.5 wt %, and very preferably 0.3-1.5 wt %, based in each case on the total weight of the dispersion for coating. Based on the PSA of the invention itself, sulfonated carboxylic esters are present preferably at in total 0.3 to 2.3 wt %, more preferably at in total 0.6 to 2.0 wt %, more particularly at 0.9 to 1.7 wt %, based in each case on the total weight of the PSA.

Another subject of the invention is an adhesive tape which comprises a PSA of the invention. The general expression “adhesive tape” for the purposes of this invention encompasses all sheetlike structures such as two-dimensionally extended sheets or sheet sections, tapes with extended length and limited width, tape sections, diecuts, labels, and the like. The adhesive tape may be provided in fixed lengths such as, for example, as product by the meter, or else as a continuous product on rolls (Archimedean spiral). In the simplest case, the adhesive tape of the invention consists only of the PSA of the invention, which for the purpose of storage and for protection from soiling is covered with a release liner; an adhesive tape of this kind is referred to generally as an adhesive transfer tape.

The adhesive tape of the invention preferably comprises a carrier. The carrier may comprise a material selected from the group consisting of paper, woven fabric, nonwoven fabric, and films made of polyester, e.g., polyethylene terephthalate (PET); polyethylene, polypropylene, e.g., oriented polypropylene; and polyvinyl chloride. The carrier preferably comprises a material selected from the group consisting of paper; woven fabric made of cotton, hemp, jute, or stinging-nettle fibers; and films made of polylactic acid, cellulose, modified starch, polyhydroxyalkanoate, biobased polypropylene, or biobased polyethylene.

More preferably the adhesive tape of the invention comprises a biodegradable carrier. More particularly the biodegradable carrier comprises paper, woven fabric, polylactic acid, cellulose, modified starch, a polyhydroxyalkanoate, a polyester PolEs which is derivable to an extent of at least 95 mol % from a monomer composition MonZ consisting of
at least one C₂— to C₁₂ alkanediol and
at least one dicarboxylic acid selected from the group consisting of oxalic acid, malonic acid, succinic acid, glutaric acid, 2-methylglutaric acid, 3-methylglutaric acid, α-ketoglutaric acid, adipic acid, pimelic acid, azelaic acid, sebacic acid, brassylic acid, fumaric acid, 2,2-dimethylglutaric acid, suberic acid, diglycolic acid, oxalacetic acid, glutamic acid, aspartic acid, itaconic acid, maleic acid and terephthalic acid or which is a polycaprolactone,

or blends of or multilayer systems composed of the above materials.

The monomer composition MonZ consists with particular preference of butanediol and at least one dicarboxylic acid selected from the group consisting of adipic acid, terephthalic acid, and succinic acid.

If the biodegradable carrier does comprise polyesters PolEs, they are present at in total at least 40 wt %, based on the total weight of the biodegradable carrier. In addition to the materials listed so far, the biodegradable carrier may generally comprise fillers. The biodegradable carrier comprises preferably up to 60 wt % of a filler or of two or more fillers selected from the group consisting of fibers, carbon black, zinc oxide, titanium dioxide; calcium carbonate, more particularly chalk; solid or hollow glass beads, microballoons, microspheres of other materials, silica, silicates, nanoparticles, wood flour, starch and starch compounds, polylactic acids and polyhydroxyalkanoates. With particular preference the biodegradable carrier comprises up to 60 wt % of at least one filler selected from the group consisting of polylactic acids and polyhydroxyalkanoates.

With particular preference the biodegradable carrier consists to an extent of at least 95 wt %, more particularly at least 98 wt %, very preferably 100 wt %, based in each case on the total weight of the biodegradable carrier, of polylactic acid, polybutylene succinate, a butanediol-adipic acid-terephthalic acid copolymer, or a blend of a butanediol-adipic acid-terephthalic acid copolymer and polylactic acid. The biodegradable carrier is preferably a film.

The biodegradable carrier may comprise further additives, examples being the adjuvants which are customary in plastics technology such as stabilizers; nucleating agents; lubricants and release agents such as stearates (especially calcium stearate); plasticizers such as, for example, citric esters (especially acetyl tributyl citrate), glyceric esters such as triacetylglycerol or ethylene glycol derivates, surfactants such as polysorbates, palmitates or laurates; waxes such as, for example, erucamide, stearamide or behenamide, beeswax or beeswax esters; antistats, UV absorbers; UV stabilizers; antifog agents; or colorants. The additives are present preferably in concentrations of 0 to 5 wt %, more particularly of 0.1 to 2 wt %, based on the total weight of the biodegradable carrier.

The carrier may be furnished on one or both sides with a PSA. In the case of double-sided furnishing with PSA, the second PSA is preferably likewise a PSA of the invention. More particularly the PSA or PSAs consist of one or more preferred polyurethanes.

The carrier may further have been subjected on the reverse face or top face, i.e., opposite to the adhesive side, to an antiadhesive physical treatment or coating, and more particularly may have been furnished with a release agent or release (optionally blended with other polymers).

Examples of release layers are those of stearyl compounds (for example, polyvinyl stearylcarbamate, stearyl compounds of transition metals such as Cr or Zr, ureas of polyethyleneimine and stearyl isocyanate) or polysiloxanes. The term “stearyl” stands as a synonym for all linear or branched alkyls or alkenyls having a C number of at least 10 such as octadecyl for example.

Suitable release agents further comprise surfactant-type release systems based on long-chain alkyl groups such as stearylsulfosuccinates or stearylsulfosuccinamates, but also polymers selected from the group consisting of polyvinyl stearylcarbamates, as for example Escoat 20 from Mayzo, polyethyleneimine stearylcarbamides, chromium complexes of C₁₄ to C₂₈ fatty acids, and stearyl copolymers, as described for example in DE 28 45 541 A. Likewise suitable are release agents based on acrylic polymers having perfluorinated alkyl groups, silicones, based for example on polydimethylsiloxanes, and fluorosilicone compounds.

Release layers in the adhesive tape of the invention are present preferably at not more than 5 wt %, based on the total weight of the adhesive tape. It has emerged that an amount of release coating up to this upper limit does not go against the biodegradability of the adhesive tape otherwise furnished in line with this criterion.

The adhesive tape of the invention may be laminated with a commercial release file or release paper, typically constructed from a base material of polyethylene, polypropylene, polyester or paper that is single-sidedly or double-sidedly coated with silicone. A structure of this kind is often also termed a release liner and in principle is not a constituent of the adhesive tape of the invention. The release liner in question here is first of all not the preferably nonbiodegradable release liner which is used in the method of the invention and from which the PSA of the invention is transferred to the carrier. Instead, the release liner in question here is intended to remain on the adhesive tape until the tape is applied, whereas the release liner of the method is intended first of all only for the purpose of transferring the PSA. Besides the siliconized release liners, it is likewise possible to use the silicone-free release systems described above. Moreover, polyolefin-based films which have not undergone further modification, such as, in particular, polypropylene, polyethylene and blends thereof, and/or multilayer laminated polypropylene/polyethylene films, may also be used.

It is, however, also possible for the release liner intended to remain on the adhesive tape up until application also to be the release liner from which the PSA of the invention is transferred to the carrier. Preferred in this sense is a laminate of PE and PP, more particularly a laminate of the form PE-PP-PE, and in the first-mentioned case the PE side is that intended for coating with the PSA of the invention, more particularly the solvent-based PSA of the invention.

The adhesive tape of the invention preferably has a peel adhesion on a steel substrate of at least 0.5 N/cm and a shear deformation of not more than 300 μm under a load of 5N at a temperature of 40° C. when applied at 20 g/m². These values are preferably also achieved after storage of three months at 23° C., 40° C. or 70° C.

Another subject of the invention is a method for producing a biodegradable adhesive tape, which comprises
providing a pressure-sensitive adhesive of the invention as a dispersion in at least one organic solvent;
coating this dispersion onto a release liner, preferably onto a nonbiodegradable release liner;
removing the organic solvent; and
transferring the pressure-sensitive adhesive onto a biodegradable carrier.

More particularly the method comprises
providing a pressure-sensitive adhesive of the invention as a dispersion in at least one organic solvent;
coating this dispersion onto a release liner, preferably onto a nonbiodegradable release liner;
removing the organic solvent;
transferring the pressure-sensitive adhesive onto a biodegradable carrier; and
removing the release liner.

The design possibilities for the biodegradable carrier are subject to what has been said above.

The term “dispersion” is understood in the context of the invention to refer to a system of a plurality of phases of which one, namely the at least one organic solvent, is continuous and at least one other, namely the pressure-sensitive adhesive, is finely distributed. Expressly included in the semantic content of the term “dispersion” is a molar dispersion, in other words the molar-disperse distribution of the PSA in the solvent or solvents, and hence a solution of the PSA therein. The term “dispersion in at least one organic solvent” means that in the context of the method of the invention, the PSA is not present in the form of an aqueous dispersion.

The method of the invention profits from the composition of the PSA of the invention, including at least one sulfonated carboxylic ester, insofar as with said composition it is possible to achieve a significant improvement in the wetting of the nonbiodegradable release liner. In the method of the invention, said release liner may serve only for transferring the PSA onto the biodegradable carrier, and thus be used as what is called a process liner; alternatively, however, it may also remain on the PSA of the invention after the latter has been applied to the carrier, until the application of the adhesive tape. Use as a process liner allows the indirect coating of a biodegradable carrier with the biodegradable PSA, since it is possible to avoid the problem of the lack of temperature stability and solvent resistance of biodegradable carrier materials.

The PSA of the invention may be applied partially or to the full area of the biodegradable carrier. Coating may also take place in the form of one or more stripes in longitudinal direction (machine direction), optionally in transverse direction, but is preferably over the full area.

The coat weight (coating thickness) of the PSA on the carrier is preferably 5 to 200 g/m², more preferably 10 to 75 g/m², and very preferably 15 to 50 g/m².

It may be advantageous to use an adhesion promoter, referred to as a primer coat, between carrier material and PSA, or to use a physical pretreatment of the carrier surface, in order to improve the adhesion of the adhesive on the carrier material. The above-described transfer of the PSA of the invention onto the biodegradable carrier also embraces the application to a biodegradable carrier provided with a primer coat.

Primers which can be used are the known dispersion-based and solvent systems, as for example those based on isoprene-containing or butadiene-containing rubber, acrylate rubber, polyvinyl rubber, polyvinylidene rubber and/or cyclo rubber. Isocyanates or epoxy resins as additives improve the adhesion and in some cases also, advantageously, raise the shear strength of the PSA. The adhesion promoter may also be applied by means of a coextrusion layer to the carrier film. From the aspect of the biodegradability of the adhesive tape of the invention, preference is given to using an at least partially biodegradable primer. With particular preference no primer is used. In the adhesive tapes of the invention, the attainable anchoring force between adhesive and carrier is generally sufficient, so making it possible advantageously to do without a primer. Physical methods for the surface treatment are optionally recruited, as for example flaming, corona, and plasma.

The carrier material may further be pretreated and/or aftertreated. Common pretreatments are hydrophobizing; common aftertreatments are calendering, heat-treating, laminating, diecutting, and enveloping.

The at least one organic solvent in the method of the invention preferably comprises a solvent selected from the group consisting of isopropanol, toluene, low-boiling alkane mixtures, and butanone. In this context it has surprisingly emerged that the addition of isopropanol does not disrupt the crosslinking of the polyurethane, as would have been expected in the form of a reaction of the alcohol with the isocyanate. It has emerged that when isopropanol is used, the wetting of the release liner with the dispersion of the PSA of the invention is particularly improved. With particular preference, therefore, the at least one solvent in the method of the invention comprises isopropanol. The solvent or solvents in the method of the invention may be removed after the dispersion of the PSA has been coated onto the release liner, in a drying tunnel or drying oven.

A further subject of the invention is the use of a sulfonated carboxylic ester as wetting agent in the coating of polyurethane-based pressure-sensitive adhesives onto carrier materials.

### Examples

Table 1 first lists the substances used for preparing the prepolymers and the crosslinked polyurethanes. The raw materials stated are all freely available commercially.

TABLE 1
Materials used for producing the example specimens

| | | | OH or NCO | | |
|---|---|---|---|---|---|
| | | | number | | |
| | | Number- | (mmol OH/kg | | |
| | | averaged | or | | |
| | Chemical | molecular | mmol | Functionality | Manufacturer/ |
| Trade name | designation/description | weight Mₙ | NCO/kg) | (f) | Supplier |
| Diols | | | | | |
| Capa 2043 ® | Polycaprolactone diol, | 400 | 4991 | 2 | Perstorp |
| | basis: 1,4-butanediol | | | | |
| | (starter), caprolactone | | | | |
| Desmophen | Polyester diol based on | 2120 | 941 | 2 | Bayer |
| 1652 ® | 1,4-butanediol, ethylene | | | | |
| | glycol, diethylene glycol, | | | | |
| | adipic acid | | | | |
| MP Diol ® | 2-Methyl-1,3-propanediol | 90.12 | 22 193 | 2 | Lyondel |
| | (CAS No.: 2163-42-0) | | | | |
| Catalyst | | | | | |
| Coscat 83 ® | Bismuth | | | | Caschem |
| | trisneodecanoate, | | | | |
| | CAS No.: 34364-26-6 | | | | |
| Isocyanates | | | | | |
| HDI | 1,6-Diisocyanatohexane | 168 | 11 891 | 2 | Sigma-Aldrich |
| | (CAS No.: 822-06-0) | | | | |
| Desmodur | HDI trimer with | about 680 | 5190 | about 3.4 | Bayer |
| N 3300 ® | polyfunctional fractions | | | | |
| Sulfo- | | | | | |
| carboxylic | | | | | |
| ester | | | | | |
| Aerosol OT | Bis-2-ethylhexyl | | | | Cytec (Solvay |
| | sulfosuccinate | | | | Group) |

A polyurethane prepolymer was prepared by first weighing out Desmophen 1652 and introducing it in a customary heatable and evacuatable laboratory mixer (in this case from PC Laborsystem) under reduced pressure at a temperature of 70° C. Then Capa 2043 was added and was incorporated by mixing without reduced pressure for 20 minutes. Thereafter the remaining substances were added, in the proportions indicated in the examples, and were incorporated by mixing for 20 minutes. Added last was the diisocyanate (HDI), which was mixed in homogeneously for 20 minutes. The chemically reacting mixture was stored in a heating cabinet at 40° C. for 7 days in order to complete the reaction.

For the crosslinking, the polyurethane prepolymer prepared was first dissolved in the specified amount of acetone. After addition of the crosslinker (Desmodur N3300) and the catalyst (Coscat 83) to the dissolved polyurethane polymer, the mixture was stirred for 5 minutes. Where a sulfonated carboxylic ester was added, it was dissolved in isopropanol, the solution was added, and the mixture was stirred for 5 minutes more. The dispersion of the chemically reacting pressure-sensitive adhesive was coated using a commercial laboratory coating table (in this case from SMO (Sondermaschinen Oschersleben GmbH)) by means of a coating knife onto the PE side of a laminated film composed of a 28 μm LDPE outer layer and a 92 μm core made of 1 impact-PP. The solvent was then evaporated off in a forced-air drying cabinet at 90° C. for 15 minutes. The slot width during coating was adjusted so as to achieve a coat weight of 20 g/m² after the solvent had been evaporated off. Thereafter the films freed from the solvent were lined with a biaxially oriented PLA film 40 μm thick (Nativia NTSS 40, from Taghleef) and laminated on by hand using a rubber roller. The specimens were stored at 23° C. and 50% relative atmospheric humidity for 7 days.

### Test Methods

Unless otherwise indicated, the measurements are carried out under test conditions of 23±1° C. and 50±5% relative humidity.

The test methods below were used to characterize the starting materials and also the specimens produced by the methods described.

### Molecular Weight Mₙ

The number-averaged average molecular weights Mₙ are determined for the purposes of the invention by means of gel permeation chromatography (GPC). The eluent used is THF (tetrahydrofuran) with 0.1 vol % of trifluoroacetic acid. The measurements take place at 25° C. The pre-column used is PSS-SDV, 5μ, 10³ Å, ID 8.0 mm×50 mm. Separation takes place using the columns PSS-SDV, 5μ, 10³ and also 10⁵ and 10⁶ each with ID 8.0 mm×300 mm. The sample concentration is 4 g/l, the flow rate 1.0 ml per minute. Measurement is made against PMMA standards.

### Hydroxyl Number

The hydroxyl numbers were determined according to DIN 53240. According to this method, the hydroxyl number (OHN) is reported in the unit [mg KOH/g]. In order to simplify the formula calculations in the examples given, the hydroxyl numbers were converted to the unit [mmol OH/kg].

This was done according to the following formula:

OHN [mmol OH/kg]=OHN [mg KOH/g]×1000/56.1

where 56.1 is the molar mass of KOH.

### Hydroxyl Functionality (f)

The hydroxyl functionality (f) is calculated from the number-averaged average molecular weight Mₙ and from the OH number (OHN) in accordance with the following equation:

f=Mₙ[g/mol]×OHN [mmol OH/kg]/10⁶.

### Peel Adhesion

The peel adhesion (peel strength) was tested in accordance with PSTC-1. A strip of the PSA tape 2 cm wide, consisting of the biaxially oriented PLA film 40 μm thick with the pressure-sensitively adhesive film about 20 μm (20 g/m²) thick applied to it, was adhered to the test plate, which had been cleaned with acetone, by being rolled over back and forth five times with a 5 kg roller. The test plate was clamped in, and the self-adhesive strip was peeled via its free end at a peel angle of 180° and at a speed of 300 mm/min, using a tensile testing machine. The force required to accomplish peeling was ascertained. The results were averaged over three measurements and reported as standardized for the width of the strip in N/cm.

The test plates were steel plates.

The peel adhesion measurements took place with freshly adhered samples and with samples which had been stored in a conditioning chamber after the bonds had been implemented. The storage conditions were 3 weeks at 40° C.

### Microshear Test

This test is used for the accelerated testing of the shear strength of adhesive tapes under temperature load.

Measurement sample preparation for microshear test:

An adhesive tape (length about 50 mm, width 10 mm) cut from the respective sample specimen was adhered to a steel test plate, which had been cleaned with acetone, in such a way that the steel plate protruded to the right and left beyond the adhesive tape and that the adhesive tape protruded beyond the test plate at the upper edge by 2 mm. The bond area of the sample in terms of height×width=13 mm×10 mm. The bond site was subsequently rolled over six times with a 2 kg steel roller at a speed of 10 m/min. The adhesive tape was reinforced flush with a stable adhesive strip which served as a support for the travel sensor. The sample was suspended vertically by means of the test plate.

Microshear Test:

The sample specimen for measurement was loaded at the bottom end with a 500 g weight. The test temperature was 40° C., the test duration 30 minutes (15 minutes of loading and 15 minutes of unloading). The shear travel after the predetermined test duration at constant temperature was reported as the result, in μm, specifically as the maximum value [“max”; maximum shear travel as a result of 15-minute loading].

### Determination of Biodegradability

The biodegradability by composting was determined in accordance with DIN EN 13432. This is a chemical test in which over the six-month test duration, a degree of degradation of 90% must be achieved relative to a reference substance in the presence of microorganisms or fungi. The conditions (temperature, oxygen content, and moisture level) are precisely defined. Degradation must take place to form water, carbon dioxide, and biomass. There is a subsequent chemical analysis and evaluation of the quality of the compost.

Likewise as part of this investigation, there is a test for disintegration behavior. The disintegration refers to the physical breakdown of a material into very small fragments.

Here, at least 90% of the plastic must have been broken down into particles smaller than 2 mm within 12 weeks. Only if both tests are passed is a substance classified as “biodegradable” in accordance with the DIN standard.

### Wetting Behavior

In order to find a suitable measure of the wetting behavior, the dispersion of the PSA was coated using a commercial laboratory coating bench (in this case from SMO (Sondermaschinen Oschersleben GmbH)) by means of a coating knife onto the release film (in this case a laminated film comprising a 28 μm LDPE outer layer and a 92 μm core made of impact-PP). The solvent was then evaporated off in a forced-air drying cabinet at 90° C. for 15 minutes. The slot width during coating was set so as to achieve a coat weight of 20 g/m² after the solvent had been evaporated off. The films freed from the solvent were subsequently cut to a size of 20×30 cm. In order to assess the wetting behavior, a count was made of all regions having an area of more than 1 mm² in which the PSA no longer completely wetted the carrier. Specimens with more than ten spots are rated here as inadequately wetted. Specimens with 5-10 spots are described as partially wetted. Ideally, the specimen has fewer than five defects and, in particular, is free from spots/defects.

### Adhesive 1 (Comparative Example, Noninventive PSA)

The composition of the polyurethane prepolymer 1 was as follows:

| Raw material | Initial mass [g] |
|---|---|
| Desmophen 1652 | 62.53 |
| Capa 2043 | 6.35 |
| Coscat 83 | 0.08 |
| HDI | 6.04 |
| Total | 75.0 |

Crosslinking Step

Polyurethane 1a:

| Raw material | Mass used [g] |
|---|---|
| PU prepolymer 1 | 75.0 |
| Acetone | 25.0 |
| Desmodur N 3300 ® | 3.14 |
| Coscat 83 | 0.08 |

### Adhesive 2 (Inventive PSA)

The composition of the polyurethane prepolymer 2 was as follows:

| Raw material | Initial mass [g] |
|---|---|
| Desmophen 1652 | 62.53 |
| Capa 2043 | 6.35 |
| Coscat 83 | 0.08 |
| HDI | 6.04 |
| Total | 75.0 |

Crosslinking Step

Polyurethane 2a:

| Raw material | Mass used [g] |
|---|---|
| PU prepolymer 2 | 75.0 |
| Acetone | 25.0 |
| Isopropanol | 5.0 |
| Desmodur N 3300 ® | 3.14 |
| Aerosol OT | 1.0 |
| Coscat 83 | 0.08 |

### Results

| | Adhesive 1 | Adhesive 2 |
|---|---|---|
| | (comparative example) | (inventive) |
| Peel adhesion, steel, | 2.4 | 2.0 |
| immediate (N/cm) | | |
| Peel adhesion, steel, 21 d | 2.4 | 2.0 |
| @ 40° C. (N/cm) | | |
| max. microshear travel, | 45 | 52 |
| 5N, 40° C. (μm) | | |
| Biodegradability >90% (d) | 166 | 138 |
| Wetting (number of spots) | 13 | 0 |

1. A biodegradable pressure-sensitive adhesive comprising
at least 60 wt % of at least one polyurethane, and
at least one sulfonated carboxylic ester.

2. The biodegradable pressure-sensitive adhesive as claimed in claim 1, wherein the at least one polyurethane is obtained by chemical crosslinking of a polyurethane prepolymer obtained by chemical reaction of
a) one or more aliphatic polyester polyols A having a hydroxyl functionality of 1.8 up to and including 2 and a number-averaged molecular weight of greater than or equal to 1000 g/mol;
b) one or more compounds B having a hydroxyl functionality of 1.8 up to and including 2 and a number-averaged molecular weight of less than 1000 g/mol;
c) one or more aliphatic diisocyanates C,
the ratio of the total number of isocyanate groups to the total number of hydroxyl groups in the substances involved in the chemical reaction for the synthesis of the prepolymer being greater than or equal to 0.4 and less than 1.

3. The biodegradable pressure-sensitive adhesive as claimed in claim 2, wherein the ratio of the total number of isocyanate groups to the total number of hydroxyl groups in the substances involved in the chemical reaction for the synthesis of the prepolymer is greater than or equal to 0.75 and less than 1.

4. The biodegradable pressure-sensitive adhesive of claim 1, wherein the at least one sulfonated carboxylic ester is a sulfonated dicarboxylic ester.

5. The biodegradable pressure-sensitive adhesive as claimed in claim 1, wherein the at least one sulfonated carboxylic ester is a symmetrically constructed sulfonated dicarboxylic ester.

6. The biodegradable pressure-sensitive adhesive as claimed in claim 1, wherein the at least one sulfonated carboxylic ester is a dialkyl ester of sulfosuccinic acid.

7. A biodegradable adhesive tape comprising a biodegradable pressure-sensitive adhesive as claimed in claim 1.

8. The biodegradable adhesive tape as claimed in claim 7, wherein the adhesive tape comprises a biodegradable carrier.

9. A method for producing a biodegradable adhesive tape, comprising
providing a pressure-sensitive adhesive as claimed in claim 1 as a dispersion in at least one organic solvent;
coating this dispersion onto a release liner;
removing the organic solvent; and
transferring the pressure-sensitive adhesive onto a biodegradable carrier.

10. The method as claimed in claim 9, wherein the at least one organic solvent comprises isopropanol.

11. The method as claimed in claim 9, wherein the biodegradable carrier comprises paper, woven fabric, polylactic acid, cellulose, modified starch, a polyhydroxyalkanoate, a
polyester PolEs which is derivable to an extent of at least 95 mol % from a monomer composition MonZ consisting of
at least one C₂- to C₁₂ alkanediol and
at least one dicarboxylic acid selected from the group consisting of oxalic acid, malonic acid, succinic acid, glutaric acid, 2-methylglutaric acid, 3-methylglutaric acid, α-ketoglutaric acid, adipic acid, pimelic acid, azelaic acid, sebacic acid, brassylic acid, fumaric acid, 2,2-dimethylglutaric acid, suberic acid, diglycolic acid, oxalacetic acid, glutamic acid, aspartic acid, itaconic acid, maleic acid and terephthalic acid
or which is a polycaprolactone,
or blends of or multilayer systems composed of the above materials.

12. A wetting agent in the coating of polyurethane-based pressure-sensitive adhesives onto carrier materials, comprising a sulfonated carboxylic ester.
